(19) United States
(12) Patent Application Publication
(10) Pub. No.: US 2024/0146513 A1
(43) Pub. Date: May 2, 2024

(54) COMMUNICATION SYSTEM, USER TERMINAL, COMMUNICATION METHOD, AND COMMUNICATION PROGRAM

(71) Applicant: NIPPON TELEGRAPH AND TELEPHONE CORPORATION, Tokyo (JP)

(72) Inventors: Hiroki ITO, Musashino-shi, Tokyo (JP); Shinichi HIRATA, Musashino-shi, Tokyo (JP); Hideo MORI, Musashino-shi, Tokyo (JP); Takeo NAGASHIMA, Musashino-shi, Tokyo (JP)

(73) Assignee: NIPPON TELEGRAPH AND TELEPHONE CORPORATION, Tokyo (JP)

(21) Appl. No.: 18/567,784

(22) PCT Filed: Jun. 10, 2021
(86) PCT No.: PCT/JP2021/022218

§ 371 Date: Dec. 7, 2023

(51) Int. Cl. H04L 9/08

(52) U.S. Cl. CPC H04L 9/0825

(57) ABSTRACT

A communication system includes a user terminal that transmits and receives a message, and a server device that manages a public key and a private key, wherein the user terminal includes first processing circuitry configured to, when transmitting the message to another user terminal, acquire a public key corresponding to identification information about a recipient of the message, and encrypt the message or a file attached to the message, using the acquired public key, transmit, to the another user terminal, a message obtained by encrypting the message or the file attached to the message, and when receiving the message from the another user terminal, request the server device to decrypt the message or the file attached to the message, and receive the decrypted message or file from the server device, and the server device includes second processing circuitry configured to generate a private key corresponding to the identification information.

### TECHNICAL FIELD

The present invention relates to a communication system, a user terminal, a communication method, and a communication program.

### BACKGROUND ART

There is a known conventional technology for performing secure transmission and reception e-mail between two areas via the Internet in a case where e-mail is used as one form of message transmission and reception (see Patent Literature 1, for example).

By such a technology, for example, in a case where the destination domain (area B) in the destination address of mail transmitted from a user terminal is a specific encryption target domain, the mail server at an area A encrypts the body of the mail (including an attached file or the like) using the public key corresponding to the destination domain, and sends the mail to the destination domain (area B). Meanwhile, the mail server at the area B checks whether the received mail is encrypted. In a case where the mail is encrypted, the mail server decrypts the mail using a private key stored in the mail server, and delivers the mail to the user terminal.

Also, a public key encryption method is normally used to encrypt and decrypt a message or an attached file or the like between a message sender and a message recipient, and conceal communication in the path in between. To implement a general public key encryption method, the message sender needs to obtain the public key necessary for sharing a key pair, or creating an encrypted message or an attached file that can be decrypted only by the message recipient, prior to encryption of the message or the attached file.

On the other hand, there is identity-based encryption (ID-based encryption, or IBE) as a method for generating a private key necessary for encryption and decryption, using a known identifier as the public key. The ID-based encryption is one of the methods according to public key encryption technologies, and is a method for characteristically generating a private key after defining a public key in generating a key pair of the private key and the public key. Accordingly, an identifier such as a mail address, a name, or any appropriate character string designated by the person who performs decryption can be used as the public key.

In the ID-based encryption, the sender encrypts a message or a file attached to the mail using the identifier acquired from the key generator, and transmits the encrypted message or file to the recipient, as in generation and decryption of encrypted text using conventional public key encryption. The recipient decrypts the encrypted message or file attached to the mail, using the private key acquired from the key generator.

Further, there is attribute-based encryption (ABE) as a method for encrypting and decrypting attributes (such as the name of the division/section to which the recipient belongs, the official position, and the decryption-allowed duration) related as the recipient, as conditions for allowing decryption.

In the attribute-based encryption, the decryption target message or a file attached to the mail is encrypted, with the policy as the conditions for decryption being included in the message or the file. The encrypted message or file is then transmitted to the recipient. Only in a case where the recipient matches the policy, can the encrypted message or the encrypted file attached to the mail be decrypted.

An example of the policy includes the identifier of the decryption-allowed user, the identifier of a decryption-allowed organization (a group of users), and a decryption-allowed duration. Also, the private key held by the recipient includes the identifier of the user and the identifier of the organization. The sender generates encrypted text in which the policy information obtained by combining these conditions is embedded in the decryption target message or a file attached to the mail, and, when the recipient decrypts the encrypted text, decryption is performed in a case where the policy information matches the policy such as the identifier embedded in the private key possessed by the recipient and the decryption timing. Since the attribute-based encryption is normally implemented to include the ID-based encryption, these two technologies will be hereinafter collectively referred to as “attribute-based encryption” in this specification. Further, there is a cloud key management technology as a method for managing the private key of the public key encryption method on the network side, instead of on a decryption-side terminal.

A key escrow technology is normally known as a method for managing the private key to be managed in a device such as a user terminal or an IC card possessed by the user in a network. The key escrow technology allows a third party (the administrator of a network or an application, or the administrator of an organization, for example) other than the sender and the recipient of encrypted text to manage a key (a common key and a private key) to be concealed in encrypted communication, and allows these administrators to decrypt the encrypted text between the sender and the recipient as necessary.

Meanwhile, the cloud key management technology is the same as the key escrow technology in that the key to be concealed in encrypted communication is escrowed with a third party other than the sender and the recipient of encrypted text, and the third party is made to decrypt the encrypted text. By the cloud key management technology, however, the recipient who wishes to decrypt encrypted communication text (encrypted text) performs a perturbation process when supplying the encrypted text to a third party. The perturbed encrypted text is decrypted by the third party while remaining perturbed, and is supplied to the recipient. At this stage, the third party cannot view the plain text in which the encryption and the perturbation have been canceled at the time of decryption. The recipient can conceal the communication text not only from any person who defrauds the communication text in the communication path but also from any person other than the recipient, including the third party who performs the decryption process.

### CITATION LIST

### Patent Literature

Patent Literature 1: Japanese Laid-open Patent Publication No. 2011-217268 A

### SUMMARY OF INVENTION

### Technical Problem

By any conventional technology, however, there are cases where simpler and safer message transmission and reception cannot be performed without key management in a user terminal.

For example, by a conventional technology, the confidentiality regarding communication between the mail server at the area A and the mail server at the area B is secured on the basis of the encryption method used for the body of mail (including an attached file or the like). However, the body of mail (including an attached file or the like) decrypted into plain text by the mail server in each area circulates as plain text in the area. Furthermore, to encrypt and decrypt mail, an attached file, or the like to be transmitted and received between the mail sender and the mail recipient, an encryption function and a decryption function are often executed in the user terminal that transmits and receives the mail.

These conventional technologies have problems described below. As for the first problem, the body of mail (including an attached file or the like) is encrypted and decrypted on a mail server basis, for example. Mail and an attached file decrypted in a mail server are distributed as plain text in the closed network in the same area. In a case where there is an attack in the closed network, the contents of the decrypted mail and the attached file might be easily viewed by the attacker.

Further, as for the second problem, the recipient of mail the sender has erroneously sent to a wrong destination (mail erroneously addressed to a user at a different destination in the same domain) can check the contents of the mail, for example. As for the body of mail and an attached file downloaded into a user terminal, it is necessary to secure confidentiality of the document on the basis of the official position, the business operation, the division/section concerned, the business project concerned, and the like, and other employees who are not involved in the business requiring the document should be prohibited from viewing the body of the mail (including the attached file or the like).

Furthermore, as a third problem, in a case where mail, an attached file, or the like to be transmitted and received between the mail sender and the mail recipient is encrypted and decrypted, for example, a key (a common key, or a public key and a private key) necessary for encryption and decryption is required between the mail sender and the mail recipient. However, key management in a user terminal is complicated.

The present invention has been made in view of the above, and aims to provide a communication system, a user terminal, a communication method, and a communication program for enabling simpler and safer message transmission and reception without key management in the user terminal.

### Solution to Problem

To solve the above problem and achieve the above objective, a communication system according to the present invention is a communication system that includes: a user terminal that transmits and receives a message; and a server device that manages a public key and a private key, wherein the user terminal includes: an encryption unit that, when transmitting the message to another user terminal, acquires a public key corresponding to identification information about a recipient of the message, and encrypts the message or a file attached to the message, using the acquired public key; a transmission unit that transmits, to the another user terminal, a message obtained by encrypting the message or the file attached to the message by the encryption unit; and a requesting unit that, when receiving the message from the another user terminal, requests the server device to decrypt the message or the file attached to the message, and receives the decrypted message or file from the server device, and the server device includes: a key generation unit that generates a private key corresponding to the identification information about the recipient of the message; and a decryption unit that, when receiving a request for decryption of the message or the file attached to the message from the user terminal, decrypts the message or the file attached to the message using the private key generated by the key generation unit, and transmits the decrypted message or file to the user terminal that has made the request for decryption.

### Advantageous Effects of Invention

According to the present invention, it is possible to perform simpler and safer message transmission and reception, without key management in a user terminal.

### BRIEF DESCRIPTION OF DRAWINGS

FIG. 1 is a block diagram illustrating an example configuration of a communication system according to a first embodiment.

FIG. 2 is a sequence diagram illustrating an example flow of processing in the communication system according to the first embodiment.

FIG. 3 is a sequence diagram illustrating an example flow of processing in the communication system according to the first embodiment.

FIG. 4 is a sequence diagram illustrating an example flow of processing in the communication system according to the first embodiment.

FIG. 5 is a block diagram illustrating an example configuration of a communication system according to a second embodiment.

FIG. 6 is a sequence diagram illustrating an example flow of processing in the communication system according to the second embodiment.

FIG. 7 is a sequence diagram illustrating an example flow of processing in the communication system according to the second embodiment.

FIG. 8 is a sequence diagram illustrating an example flow of processing in the communication system according to the second embodiment.

FIG. 9 is a diagram illustrating an example of an encryption policy setting screen.

FIG. 10 is a diagram illustrating a computer that executes a communication program.

### DESCRIPTION OF EMBODIMENTS

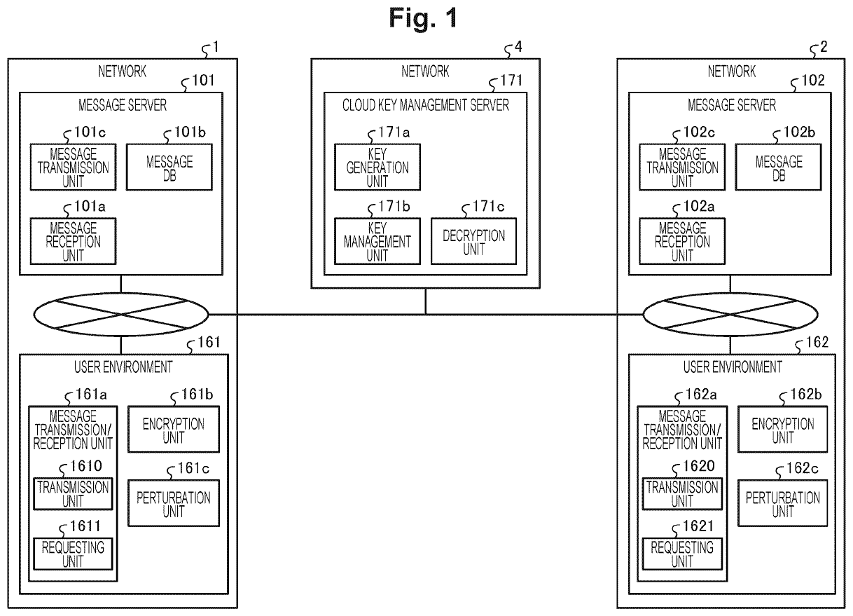

The following is a detailed description of embodiments of communication systems, user terminals, communication methods, and communication programs according to the present application, with reference to the drawings. Note that communication systems, user terminals, communication methods, and communication programs according to the present application are not limited by these embodiments.

[First Embodiment] In the description below, a configuration of a communication system according to a first embodiment and a flow of processing in the communication system are sequentially explained, and lastly, the effects of the first embodiment are explained.

[Configuration of a communication System] First, an example configuration of a communication system according to this embodiment is described with reference to FIG. 1. FIG. 1 is a block diagram illustrating an example configuration of a communication system according to the first embodiment. Note that the configuration illustrated in FIG. 1 is merely an example, and specific configurations are not particularly limited to this configuration.

As illustrated in FIG. 1, the communication system of this embodiment includes a message server 101 and a user environment 161 in a network 1, and these are connected to each other in the network 1. The communication system of this embodiment also includes a message server 102 and a user environment 162 in a network 2, and these are connected to each other in the network 2. Note that the user environments 161 and 162 may have any configuration herein, but include at least a user terminal.

The communication system of this embodiment also includes a cloud key management server 171 in a network 4. Further, the network 1, the network 2, and the network 4 are connected to one another. Note that the message server 101 and the message server 102 transmit and receive messages of the same protocol to and from each other, and have the same configurations accordingly.

The user environment 161 and the user environment 162 are assigned to individual users and transmit and receive messages to and from each other, and have the same configurations accordingly. In view of this, the network 1 and the network 2 have the same configurations. However, the description below is based primarily on the assumption of an example case where a message is transmitted from the user environment 161 to the user environment 162.

The message server 101 includes: a message reception unit 101a that receives a message transmitted from a message transmission/reception function of the user environment 161: a message DB 101b that temporarily stores the message; and a message transmission unit 101c that identifies the message addressed to a user on the basis of a message reception request from the user environment 162 being used by the user at the destination of the message, and transmits the message to the user environment 162. Note that the message server 102 has the same configuration as the message server 101, and therefore, explanation thereof is not made herein.

The user environment 161 includes: a message transmission/reception unit 161a that distributes the message via the message server 101 and the message server 102; an encryption unit 161b necessary for encrypting the message or a file attached to the message; and a perturbation unit 161c that perturbs the message or the file attached to the message. Note that the user environment 162 has the same configuration as the user environment 161, and therefore, explanation thereof is not made herein.

In a case where a message is transmitted to another user terminal (the user environment 162), the encryption unit 161b acquires a public key corresponding to identification information (a mail address of the recipient, for example) about the recipient of the message, and, using the acquired public key, encrypts the message or a file attached to the message. For example, the encryption unit 161b uses the conventional ID-based encryption, to encrypt the message or the file attached to the message, with an identifier such as a mail address or the name of the recipient being used as a public key (see Reference Literature 1, for example).

Reference Literature 1: Kobayashi, Yamamoto, Suzuki, and Hirata, “Applications of ID-Based Encryption, and Public Key Encryption with Keyword Search”, NTT Technical Journal, February 2010

The message transmission/reception unit 161a includes a transmission unit 1610 and a requesting unit 1611. The transmission unit 1610 transmits the message or the file attached to the message encrypted by the encryption unit 161b, to another user terminal (the user environment 162).

In a case where a message is received from another user terminal (the user environment 162), the requesting unit 1611 requests the cloud key management server 171 to decrypt the message or a file attached to the message, and receives the decrypted message or file from the cloud key management server 171.

The perturbation unit 161c perturbs the message or the file attached to the message encrypted by the encryption unit 161b.

The cloud key management server 171 includes a key generation unit 171a, a key management unit 171b, and a decryption unit 171c. The key generation unit 171a generates a private key corresponding to the identification information about the recipient of the message.

The key management unit 171b stores both the public key and the private key corresponding to the message recipient. For example, in a case where a request for a private key is received from the user environment 161, the key management unit 171b transmits the private key to the user environment 161 when the requested private key is stored therein, and transmits a generated private key to the user environment 161 after requesting the key generation unit 171a to generate the private key when the requested private key is not stored therein.

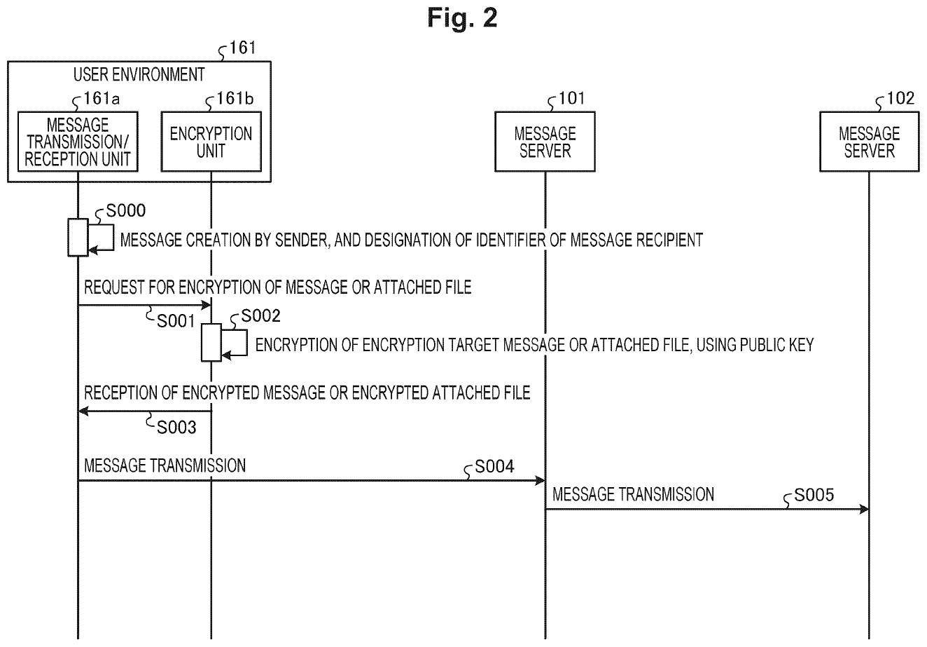

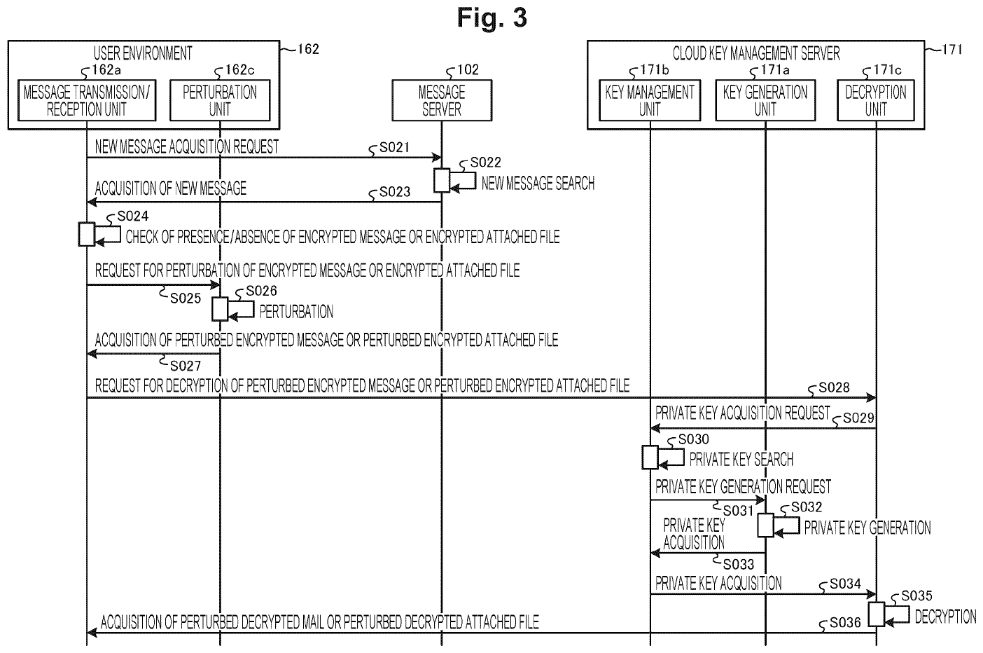

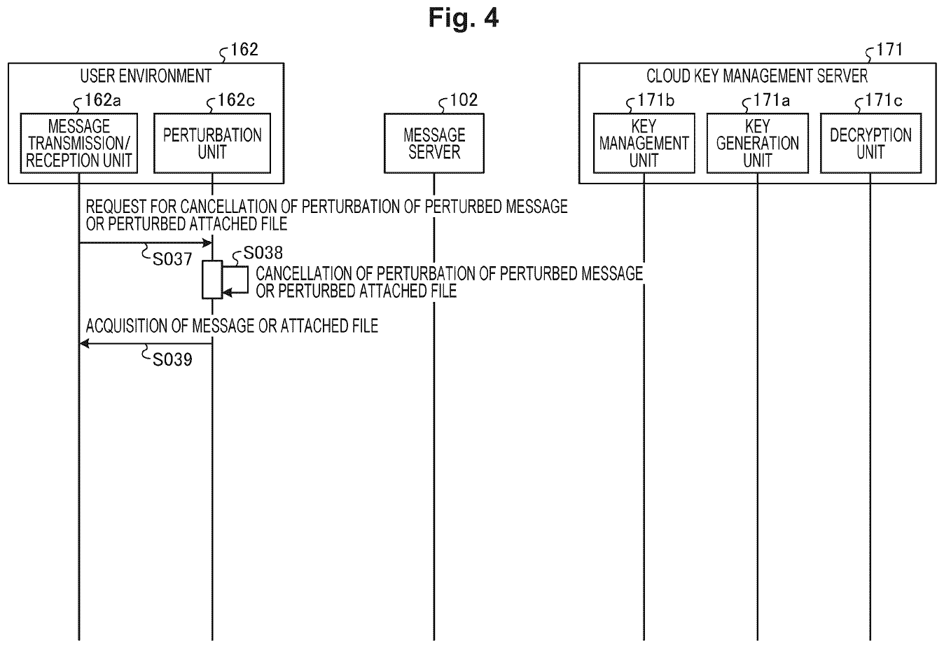

In a case where a request for decrypting the message or a file attached to the message is received from a user terminal (the user environment 161), the decryption unit 171c decrypts the message or the file attached to the message using the private key generated by the key generation unit 171a, and transmits the decrypted message or file to the user terminal (the user environment 161) that has made the request for decryption.

[Processing Procedures in the Communication System] Next, an example of the processing procedures in a communication process to be performed by the communication system is described with reference to FIGS. 2 to 4. FIGS. 2 to 4 are sequence diagrams illustrating an example flow of processing in the communication system according to the first embodiment.

As illustrated in FIGS. 2 to 4, a message sender creates a message addressed to the recipient of the message, using the user environment 161. The body of the message or a file attached to the message is intended to prevent a third party other than the sender of the message or the recipient of the message from viewing. The message sender designates the message or the file attached to the message, and the identifier of the message recipient (a mail address of the recipient, for example) (S000).

The message transmission/reception unit 161a of the user environment 161 then requests the encryption unit 161b to encrypt the message or the attached file, using the identifier of the message recipient as the public key (S001). The encryption unit 161b encrypts the message or the attached file using the public key (S002), and replies to the message transmission/reception unit 161a (S003).

The message transmission/reception unit 161a of the user environment 161 then transmits the encrypted message or the encrypted attached file to the message server 101 (S004). The message server 101 transmits the encrypted message or the encrypted attached file to the message server 102 of the network 2 to which the user environment 161 being used by the message recipient belongs (S005).

Subsequently, the message transmission/reception unit 162a of the user environment 162 requests the message server 102 to acquire a new message (S021). The message server 102 then searches for a new message addressed to the message recipient (S022), and replies with the new message to the message transmission/reception unit 162a of the user environment 162 (S023).

The message transmission/reception unit 162a of the user environment 162 then checks the presence/absence of an encrypted message or an encrypted attached file in the acquired new message (S024), and, if the new message includes an encrypted message or an encrypted attached file, requests the perturbation unit 162c to perturb the encrypted message or the encrypted attached file (S025). The perturbation unit 162c performs a perturbation process (S026), and replies with the perturbed encrypted message or the perturbed encrypted attached file to the message transmission/reception unit 162a (S027).

Subsequently, the message transmission/reception unit 162a of the user environment 162 transmits the perturbed encrypted message or the perturbed encrypted attached file to an encryption processing function in the cloud key management server 171, and requests decryption (S028). The decryption unit 171c then requests the key management unit 171b in the cloud key management server 171 for the private key corresponding to the message recipient (S029). If the private key corresponding to the message recipient cannot be retrieved (S030), the key management unit 171b requests a key generation function in the cloud key management server 171 to generate the private key (S031).

The key generation unit 171a then generates the private key corresponding to the message recipient (S032), and replies to the key management unit 171b (S033). The key management unit 171b replies with the private key to the encryption processing function (S034). The decryption unit 171c uses the private key, to decrypt the perturbed encrypted message or the perturbed encrypted attached file (S035), and replies with the perturbed decrypted mail or the perturbed decrypted attached file to the message transmission/reception unit 162a in the user environment 162 (S036).

Subsequently, the message transmission/reception unit 162a of the user environment 162 requests the perturbation unit 162c to cancel the perturbation in the perturbed message or the perturbed attached file (S037). The perturbation unit 162c performs a perturbation cancellation process (S038), and replies with the message or the attached file to the message transmission/reception unit 162a (S039).

[Effects of the First Embodiment] As described above, in a case where the user environment 161 transmits a message to another user environment 162 in the communication system according to the first embodiment, the public key corresponding to identification information (a mail address of the recipient, for example) about the recipient of the message is acquired, and the message or a file attached to the message is encrypted with the use of the acquired public key. The user environment 161 then transmits a message obtained by encrypting the message or the file attached to the message, to another user terminal. Meanwhile, in a case where the user environment 162 has received a message from another user environment 161, the user environment 162 requests the cloud key management server 171 to decrypt the message or a file attached to the message, and receives the decrypted message or file from the cloud key management server 171.

That is, in the communication system, the public key corresponding to identification information about the message recipient is obtained and encrypted at the time of mail transmission, and the cloud key management server 171 is requested to perform decryption at the time of mail reception. Thus, it is possible to perform simpler and safer message transmission and reception, without key management in the user terminal. For example, in the communication system according to the first embodiment, the public key corresponding to identification information about the recipient of the message is used, to encrypt and transmit/receive the body of an e-mail message or an attached file between the user environment 161 of the sender and the user environment 162 of the recipient. Also, in the communication system according to the first embodiment, it is possible to form a secure message transmission/reception function that minimizes key management on the user terminal side.

[Second Embodiment] In the second embodiment described below, a case where a directory server is provided in a network, and policy setting using attribute-based encryption is performed is explained. Note that explanation of the components and processes that are the same as those of the first embodiment is not made herein.

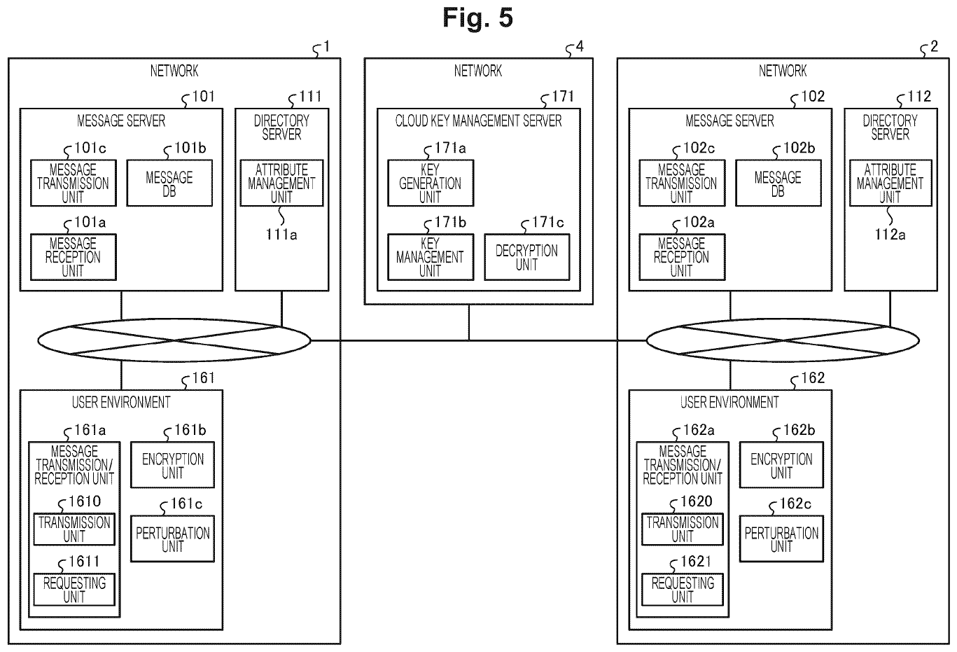

FIG. 5 is a block diagram illustrating an example configuration of a communication system according to the second embodiment. As illustrated in FIG. 5, the networks 1 and 2 include directory servers 111 and 112, respectively.

The directory server 111 manages attributes related to users present in the network 1, and provides the attributes in response to requests for other functions. The attributes in this case include an identifier for identifying a user such as a mail address or the account name at the time of login, affiliation information indicating a group to which the user belongs, an official position, authority, and the like, and general attribute information associated with the individual such as the name necessary for the user to use not only this system in the network but also any system connected in the network.

The directory server 111 includes an attribute management unit 111a. The attribute management unit 111a stores attribute information about each user, identifiers necessary for message exchange managed in the network, and user account being used in the network. For example, the attribute management unit 111a stores, as the attribute information, affiliation information indicating the groups to which the respective users belong, official positions, authorities, and the like. Note that the directory server 111 and the directory server 112 have the same configurations, and explanation of the directory server 112 is not made herein.

Further, in a case where a message is transmitted to another user terminal (the user environment 162), the encryption unit 161b of the user environment 161 acquires a public key corresponding to the attribute information about the recipient of the message, and, using the acquired public key, encrypts the message or a file attached to the message.

For example, the encryption unit 161b may encrypt the message or the file attached to the message, with policy information included in the message or the file, the policy information indicating conditions for allowing decryption. For example, the encryption unit 161b may encrypt the decryption target message or a file attached to the mail including a decryption condition policy, using a conventional attribute-based encryption technique (see Reference Literature 2, for example).

Reference Literature 2: Abe, Tokunaga, Mehdi, Nishimaki, and Kusagawa, “The Forefront of Cryptology Studies for Coping with Changes in Computation Environments”, NTT Technical Journal, February 2020

An example of the policy includes the identifier of the decryption-allowed user, the identifier of a decryption-allowed organization (a group of users), and a decryption-allowed duration. The encryption unit 161b generates encrypted text in which the policy information obtained by combining conditions such as the identifier of the decryption-allowed user, the identifier of a decryption-allowed organization (a group of users), and a decryption-allowed duration is embedded in the decryption target message or a file attached to the mail.

The key generation unit 171a generates a key pair that enables encryption and decryption of the body of the message or the attached file, the key pair being associated with the user account, affiliation information about the organization and the official position to which the user account belongs, and usage conditions such as the available time slot, the available terminal, or the available network.

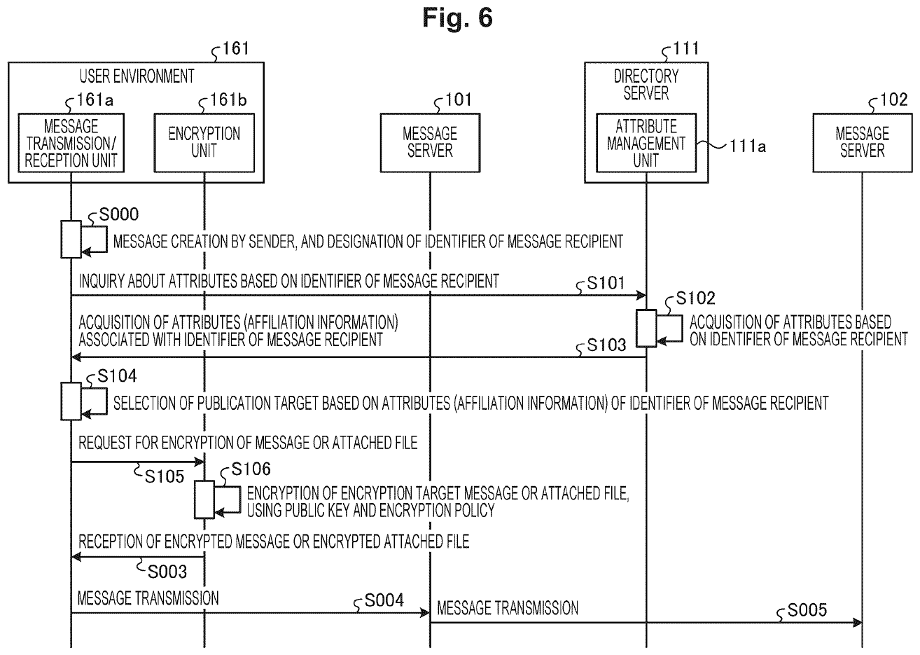

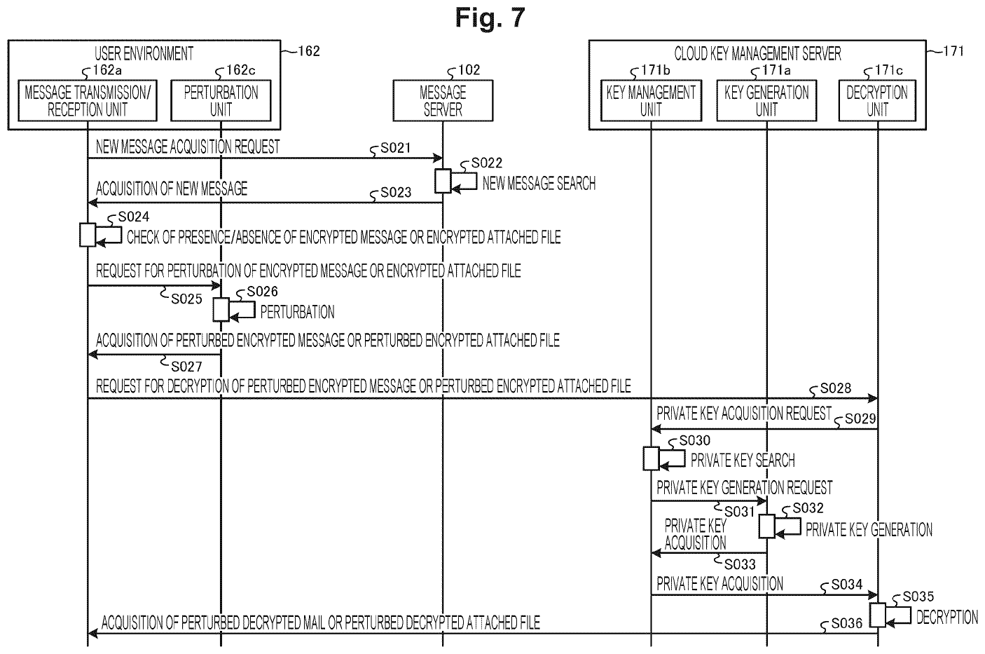

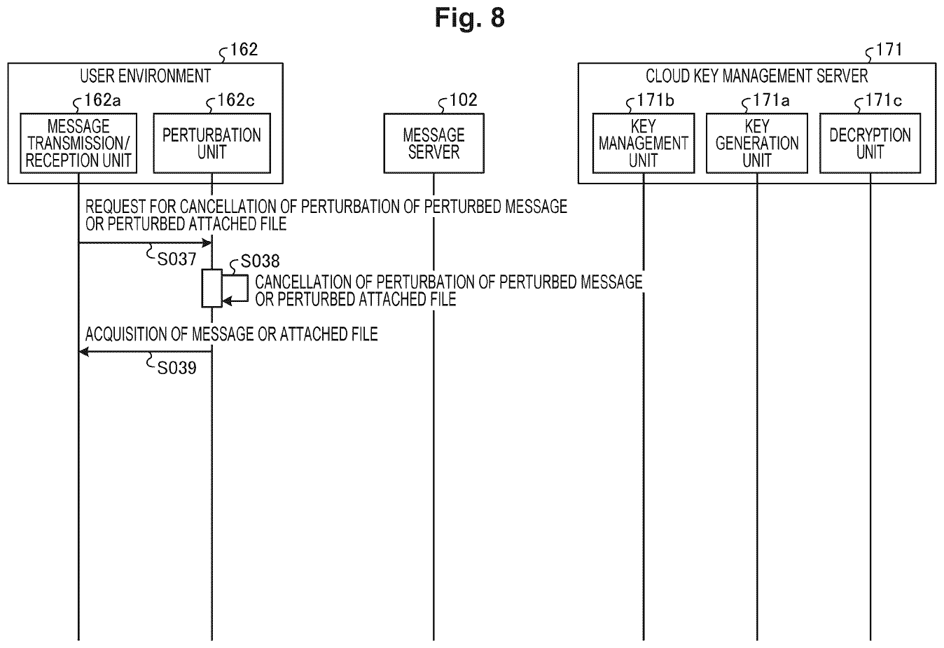

The decryption unit 171c of the cloud key management server performs decryption in a case where the identification information embedded in the private key possessed by the recipient, the decryption timing, and the like match the policy. Note that the private key held by the recipient herein includes the identifier of the user and the identifier of the organization, for example.

[Processing Procedures in the Communication System] Next, an example of the processing procedures in a communication process to be performed by the communication system is described with reference to FIGS. 6 to 8. FIGS. 6 to 8 are sequence diagrams illustrating an example flow of processing in the communication system according to the second embodiment.

As illustrated in FIGS. 6 to 8, when the message sender creates a message addressed to the message recipient, the message transmission/reception unit 161a of the user environment 161 requests the directory server 111 for the affiliation information indicating a group to which the message recipient belongs, the official position, the authority, and the like, on the basis of the identifier of the message recipient (S101).

The directory server 111 then acquires the affiliation information related to the message recipient from an attribute management function on the basis of the identifier of the message recipient (S102), and supplies the affiliation information to the message transmission/reception unit 161a of the user environment 161 (S103).

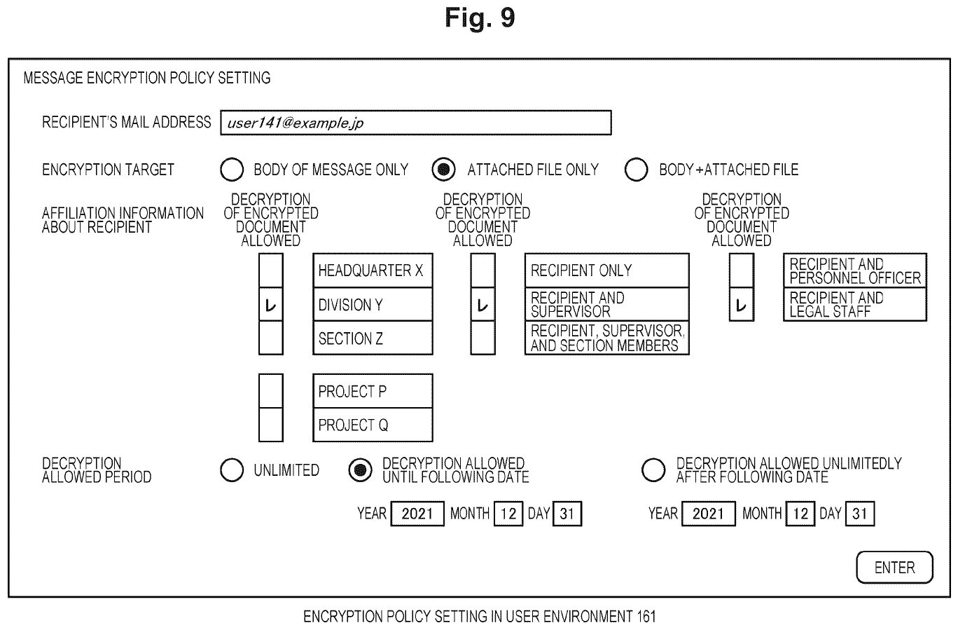

Subsequently, on the basis of the affiliation information, the message transmission/reception unit 161a of the user environment 161 presents a message encryption policy setting screen illustrated in FIG. 9 to the message sender, and causes the message sender to input the encryption policy (S104). FIG. 9 is a diagram illustrating an example of the encryption policy setting screen.

On the basis of the encryption policy, the message transmission/reception unit 161a of the user environment 161 requests the encryption processing function to encrypt the message or the attached file (S105). The encryption unit 161b then encrypts the message or the attached file, using the identifier and the encryption policy (S106). Note that the flow of processing thereafter is the same as that of the first embodiment, and therefore, explanation thereof is not made herein.

[System Configuration and the Like] Further, each of the components of each of the devices illustrated in the drawings is functionally conceptual, and is not required to be physically designed as illustrated. That is, specific modes of distribution and integration of devices are not limited to those illustrated in the drawings, and all or some of the devices can be functionally or physically distributed and integrated in any appropriate unit in accordance with various loads, usage conditions, and the like. Although the description of the above embodiments concerns cases where the occurrence of an event on an operation screen displayed on an operation log acquisition device is detected, and an operation log is recorded, the present invention is not limited these cases. For example, the operation log acquisition device may detect an event on an operation screen displayed on another terminal, and record an operation log. Further, all or some of the processing functions executed in the respective devices can be implemented by a CPU and a program to be analyzed and executed by the CPU, or can be implemented as hardware by wired logic.

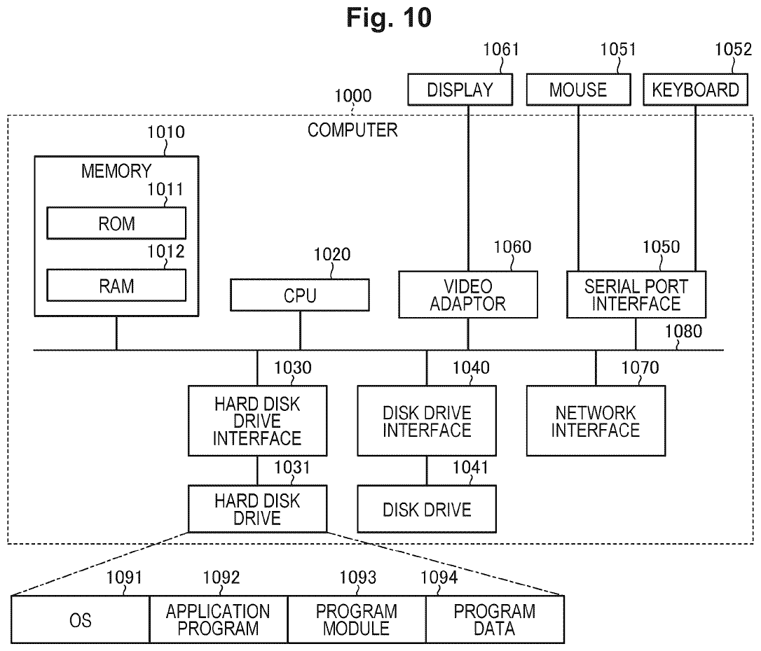

Also, among the individual processes described in these embodiments, all or some of the processes described as being performed automatically can be performed manually, or all or some of the processes described as being performed manually can be performed automatically by a known method. In addition to the above, the processing procedures, the control procedures, the specific names, and the information including various kinds of data and parameters that are illustrated in the above literatures and drawings can be changed as appropriate, unless otherwise specified.

[Program] FIG. 10 is a diagram illustrating a computer that executes a communication program. A computer 1000 includes a memory 1010 and a CPU 1020, for example. The computer 1000 also includes a hard disk drive interface 1030, a disk drive interface 1040, a serial port interface 1050, a video adapter 1060, and a network interface 1070. These components are connected by a bus 1080.

The memory 1010 includes a ROM 1011 and a RAM 1012. The ROM 1011 stores a boot program such as a basic input output system (BIOS), for example. The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. The serial port interface 1050 is connected to a mouse 1051 and a keyboard 1052, for example. The video adapter 1060 is connected to a display 1061, for example.

The hard disk drive 1031 stores an operating system (OS) 1091, an application program 1092, a program module 1093, and program data 1094, for example. That is, the program that defines the respective processes to be performed by the respective devices is implemented as the program module 1093 in which codes that can be executed by the computer 1000 are written. The program module 1093 is stored in the hard disk drive 1031, for example. The program module 1093 for performed the same processes as in the functional configuration in a user terminal is stored in the hard disk drive 1031, for example. Note that the hard disk drive 1031 may be replaced with a solid state drive (SSD).

Also, the setting data that is used in the processes according to the above embodiments is stored as the program data 1094 in the memory 1010 or the hard disk drive 1031, for example. The CPU 1020 then reads the program module 1093 and the program data 1094 stored in the memory 1010 or the hard disk drive 1031 into the RAM 1012 as necessary, to execute them.

Note that the program module 1093 and the program data 1094 are not necessarily stored in the hard disk drive 1031, but may be stored in a removable storage medium and be read by the CPU 1020 via the disk drive 1041 or the like, for example. Alternatively, the program module 1093 and the program data 1094 may be stored in another computer connected via a network (a local area network (LAN), a wide area network (WAN), or the like). The program module 1093 and the program data 1094 may be read from another computer by the CPU 1020 via the network interface 1070.

While the embodiments to which the invention made by the present inventors is applied have been described above, the present invention is not limited by the description and the drawings constituting part of the disclosure of the above embodiments according to the present invention. That is, other embodiments, examples, operation techniques, and the like made by those skilled in the art and the like on the basis of the above embodiments are all included in the scope of the present invention.

### REFERENCE SIGNS LIST

1, 2, 4 network
101, 102 message server
101a, 102a message reception unit
101b, 102b message DB
101c, 102c message transmission unit
161, 162 user environment
161a, 162a message transmission/reception unit
161b, 162b encryption unit
161c, 162c perturbation unit
171 cloud key management server
171a key issuance unit
171b key management unit
171c decryption unit
1610, 1620 transmission unit
1611, 1621 requesting unit

1. A communication system comprising: a user terminal that transmits and receives a message; and a server device that manages a public key and a private key, wherein
the user terminal includes:
first processing circuitry configured to:
when transmitting the message to another user terminal, acquire a public key corresponding to identification information about a recipient of the message, and encrypt the message or a file attached to the message, using the acquired public key;
transmit, to the another user terminal, a message obtained by encrypting the message or the file attached to the message; and
when receiving the message from the another user terminal, request the server device to decrypt the message or the file attached to the message, and receive the decrypted message or file from the server device, and the server device includes:
second processing circuitry configured to:
generate a private key corresponding to the identification information about the recipient of the message; and
when receiving a request for decryption of the message or the file attached to the message from the user terminal, decrypt the message or the file attached to the message using the private key generated, and transmit the decrypted message or file to the user terminal that has made the request for decryption.

2. The communication system according to claim 1,
wherein the first processing circuitry is further configured to perturb the message or the file attached to the message encrypted.

3. The communication system according to claim 1,
wherein the first processing circuitry is further configured to encrypt the message or the file attached to the message, with policy information included in the message or the file, the policy information indicating a condition for allowing decryption.

4. A user terminal comprising:
processing circuitry configured to:
when transmitting a message to another user terminal, acquire a public key corresponding to identification information about a recipient of the message, and encrypt the message or a file attached to the message, using the acquired public key;
transmit, to the another user terminal, a message obtained by encrypting the message or the file attached to the message; and
when receiving the message from the another user terminal, request a server device to decrypt the message or the file attached to the message, and receive the decrypted message or file from the server device.

5. A communication method implemented by a communication system that includes: a user terminal that transmits and receives a message; and a server device that manages a public key and a private key,
the communication method comprising:
by the user terminal, when transmitting the message to another user terminal, acquiring a public key corresponding to identification information about a recipient of the message, and encrypting the message or a file attached to the message, using the acquired public key;
by the user terminal, transmitting, to the another user terminal, a message obtained in the encryption in which the message or the file attached to the message has been encrypted;
by the user terminal, when receiving the message from the another user terminal, requesting the server device to decrypt the message or the file attached to the message;
by the server device, generating a private key corresponding to the identification information about the recipient of the message; and
by the server device, when receiving a request for decryption of the message or the file attached to the message from the user terminal, decrypting the message or the file attached to the message using the private key generated, and transmitting the decrypted message or file to the user terminal that has made the request for decryption.

6. (canceled)
